(19) United States
(12) Patent Application Publication
(10) Pub. No.: US 2011/0299116 A1
(43) Pub. Date: Dec. 8, 2011

(54) PRINT INSTRUCTION DEVICE, IMAGE FORMING APPARATUS, AND PRINT INSTRUCTION METHOD

(75) Inventor: Makoto Hibino, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/118,818

(22) Filed: May 31, 2011

Related U.S. Application Data
(60) Provisional application No. 61/350,635, filed on Jun. 2, 2010.

(51) Int. Cl. G06F 3/12

(52) U.S. Cl. 358/1.15

(57) ABSTRACT

According to one embodiment, there is provided a print instruction device including an acquisition section, a calculation section, a display section, and a transmission section. The acquisition section acquires recommended setting corresponding to user information from an image forming apparatus. The calculation section calculates the amount of consumption of the Quota value by a print process according to the recommended setting that the acquisition section acquired from the image forming apparatus. The display section displays the recommended setting acquired by the acquisition section and the amount of the Quota value consumed by the print process according to the recommended setting, calculated by the calculation section. The transmission section transmits print data including a print setting content instructed by a user to the image forming apparatus after the recommended setting is displayed on the display section.

### CROSS-REFERENCE TO RELATED APPLICATIONS

This application is based upon and claims the benefit of priority from U.S. Provisional Application No. 61/350,635 filed on Jun. 2, 2010; the entire contents of which are incorporated herein by reference.

### FIELD

Embodiments described herein relate generally to a print instruction device, an image forming apparatus, and a print instruction method.

### BACKGROUND

Conventionally, in image forming apparatuses such as a digital multi-function peripheral, it is difficult for users to make settings of processes while taking the cost consumed by the processes that the users want to execute into account. Moreover, even if a user issues a print request to an image forming apparatus from a user terminal, it is not easy for the user to make appropriate print settings while suppressing the cost in the image forming apparatus.

### BRIEF DESCRIPTION OF THE DRAWINGS

FIG. 1 is a diagram schematically showing an exemplary configuration of a digital multi-function peripheral.

FIG. 2 is a block diagram showing an exemplary configuration of a control system of the digital multi-function peripheral and a user terminal.

FIG. 3 shows an exemplary configuration of a Quota table.

FIG. 4 shows an exemplary configuration of a recommended setting table.

FIG. 5 shows an exemplary configuration of a role table.

FIG. 6 shows an exemplary configuration of the recommended setting table for respective roles.

FIG. 7 is a flowchart showing an exemplary operation of the user terminal during printing process.

FIG. 8 is a flowchart showing an exemplary operation of the digital multi-function peripheral during a print process.

FIG. 9 shows a display example of a selection screen for a recommended setting and other setting candidates.

FIG. 10 is a flowchart showing an example of a process of registering a recommended setting.

FIG. 11 is a flowchart showing an exemplary operation of the digital multi-function peripheral during a copy process.

### DETAILED DESCRIPTION

In general, according to one embodiment, a print instruction device includes an acquisition section, a calculation section, a display section, and a transmission section. The acquisition section acquires recommended setting corresponding to user information from an image forming apparatus. The calculation section calculates the amount of consumption of the Quota value by a print process according to the recommended setting that the acquisition section acquired from the image forming apparatus. The display section displays the recommended setting acquired by the acquisition section and the amount of the Quota value consumed by the print process according to the recommended setting, calculated by the calculation section. The transmission section transmits print data including a print setting content instructed by a user to the image forming apparatus after the recommended setting is displayed on the display section.

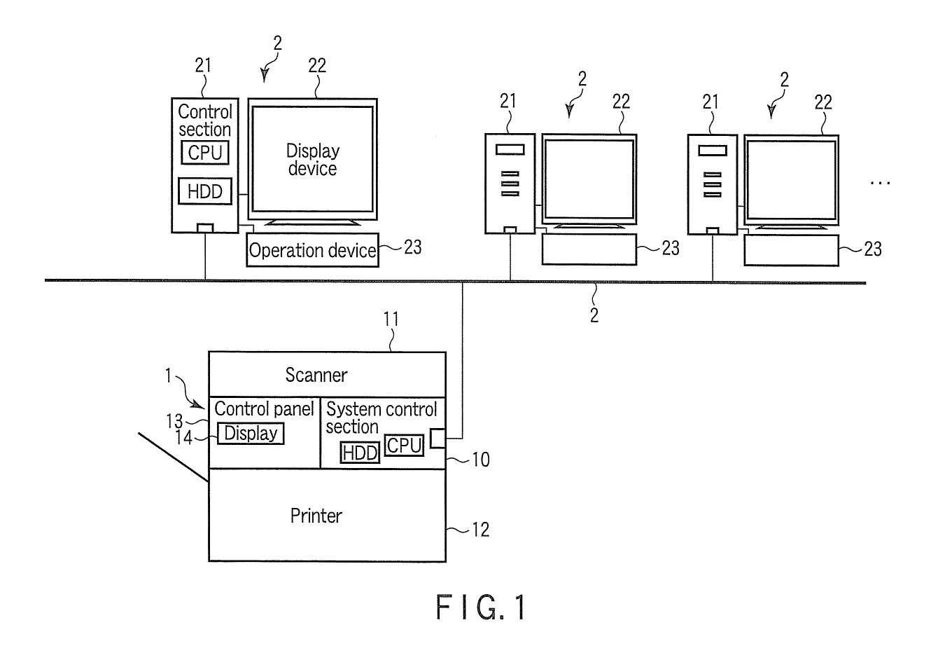

Hereinafter, an embodiment of the invention will be described in detail with reference to the drawings. FIG. 1 is a diagram showing an exemplary configuration of an image forming system.

In the image forming system of the exemplary configuration shown in FIG. 1, a digital multi-function peripheral 1 is connected to a plurality of user terminals 2 through a network 3. Moreover, the image forming system may have a configuration in which various server devices or the like are connected to a network.

The digital multi-function peripheral 1 functions as an image forming apparatus. The digital multi-function peripheral 1 has a scan function, a print function, a copy function, a network communication function, and a user authentication function. In the exemplary configuration shown in FIG. 1, the digital multi-function peripheral 1 includes a system control section 10, a scanner 11, a printer 12, an operation panel 13, a display 14, and the like.

The system control section 10 includes a processor (for example, a CPU), a storage device (for example, a hard disk drive), a network interface, and the like. In the digital multi-function peripheral 1, the system control section 10 controls respective parts if the processor executes a program stored in the storage device. For example, the system control section 10 controls the respective parts to execute a scan function, a print function, a copy function, a network communication function, and a user authentication function.

The scanner 11 converts an image on an original document surface into image data. For example, the scanner 11 optically scans the original document surface to read an image on the document surface as color image data or monochrome image data. The scanner 11 includes a scanning mechanism, a photoelectric converter, a document feeder (ADF), and the like.

The printer 12 forms an image on a recording medium such as a sheet. For example, the printer 12 forms a color image or a monochrome image on a sheet. The printer 12 may perform printing by a printing method such as an electrophotographic method, an ink jet method, or a heat-transfer method. The printer of the digital multi-function peripheral of the present embodiment is assumed to be a printer which uses an electrophotographic method, for example.

The operation panel 13 and the display 14 constitute a user interface. The operation panel 13 includes various operation keys, for example. The display 14 is configured by a display device having a built-in touch panel. The display 14 displays an operation guide or icons which can be selected on a touch panel. The operation panel 13 also functions as an authentication information acquisition section that acquires authentication information that is input by a user. The authentication information may be acquired by an authentication information reader that reads authentication information from a storage medium (for example, an IC card or a mobile terminal) possessed by a user and may be acquired by an authentication information reader that reads biological information of a user as authentication information.

The respective user terminals 2 function as print instruction devices that allow respective users to issue a print request to the digital multi-function peripheral. For example, the user terminal 2 is configured by a computer that has a network communication function. The user terminal 2 functions as a print instruction device if a processor executes a printer driver program corresponding to the digital multi-function peripheral 1. The user terminal 2 may be an electronic device which is capable of communicating with the digital multi-function peripheral 1 and transmitting print data including print settings generated by a printer driver to the digital multi-function peripheral 1. For example, the user terminal 2 may be a mobile terminal or the like.

In the exemplary configuration shown in FIG. 1, the user terminal 2 includes a control section 21, a display (display section) 22, and an operation device (operation section) 23.

The control section 21 includes a processor (for example, a CPU), a storage device (for example, a hard disk drive), a network interface, and the like. The control section 21 of the user terminal 2 realizes various processing functions if the processor executes a program stored in the storage device. For example, the control section 21 executes a printer driver program (hereinafter simply referred to as a “printer driver”) for the digital multi-function peripheral 1 to thereby display a setting screen of printing executed by the digital multi-function peripheral 1 to the display 22, generate print data including image data to be printed and setting information input by the operation device 23, and transmit the generated print data to the digital multi-function peripheral 1 through a network.

Next, a configuration of a control system of the digital multi-function peripheral 1 will be described.

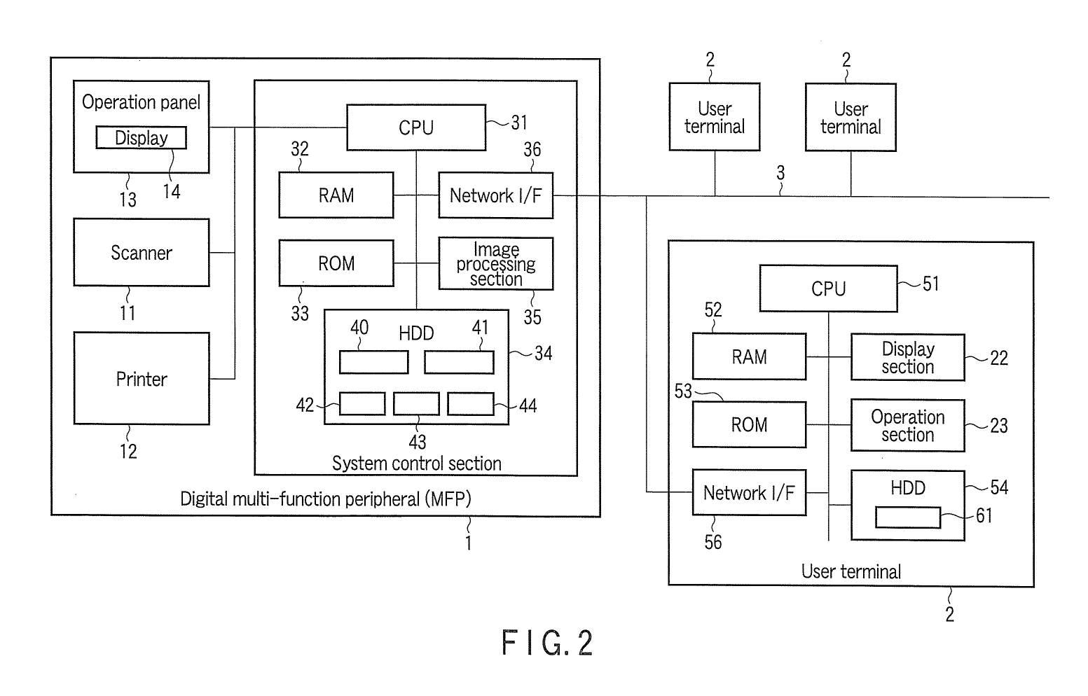

FIG. 2 is a block diagram showing an exemplary configuration of a control system of the digital multi-function peripheral 1 and the user terminal 2.

As shown in FIG. 2, the system control section 10 of the digital multi-function peripheral 1 is connected to the scanner 11, the printer 12, the operation panel 13, and the display 14. For example, the system control section 10 realizes a network printer function wherein the printer 12 performs a print process based on print data (PDL data) received from the user terminal 2 through the network 3. Moreover, the system control section 10 realizes a copy function wherein the scanner 11 reads an image of an original document and the printer 12 prints the read original document image on a sheet.

As shown in FIG. 2, the system control section 10 includes a processor (CPU) 31, a random access memory (RAM) 32, a read only memory (ROM) 33, a hard disk drive (HDD) 34, an image processing section 35, a network interface (I/F) 36, and the like.

The CPU 31 is a processor. The CPU 31 realizes various processing functions by executing control programs stored in the ROM 33 and the HDD 34. The RAM 32 is a main memory that functions as a working memory. The ROM 33 stores a control program for controlling the operation of the digital multi-function peripheral 1, control data, and the like. The HDD 34 is a rewritable nonvolatile memory.

The HDD 34 stores a control program for realizing various processing functions, control data, and the like. Moreover, the HDD 34 stores various data such as image data read by the scanner 11 or print data including image data received through a network. The image processing section 35 performs image processing. For example, in the case of a copy process, the image processing section 35 converts image data read by the scanner 11 into image data for printing corresponding to properties of the printer 12.

The network interface (NW I/F) 36 is an interface that allows the digital multi-function peripheral 1 to communicate data with the user terminal 2 as an external device through the network 3. The network interface 36 receives print data requested for printing through a network from the user terminal 2 in which a printer driver program for the digital multi-function peripheral 1 is installed.

In the HDD 34, an allocation database 40 of Quota values, a Quota table 41, a recommended setting table 42, a role table 43, a recommended setting table 44 for respective roles, and the like are stored.

The allocation database 40 stores information indicating Quota values allocated to respective users or respective groups made up of a plurality of users. The Quota value is a value indicating the amount (numeric value) allocated to a user or a group, in which the numeric value corresponds to the cost consumed by an executed process, the emission amount of carbon dioxide generated by an executed process, or the like. The allocation database 40 is updated if ever executing a process in accordance with instructions of respective users. For example, in the allocation database 40, the amount of consumption of the Quota value corresponding to the content (setting content) of the executed process is subtracted from the Quota value allocated to the respective users or groups. That is, the allocation database 40 stores a value indicating the residual amount of the Quota value allocated to the respective user or the respective groups.

The Quota table 41 stores information indicating the amount of consumption of the Quota value for each of various setting items. The amount of consumption of the Quota value for a setting content made up of a plurality of setting items is calculated based on the amount of consumption of the Quota value for the respective setting items stored in the Quota table 41. The recommended setting table 42 stores information indicating the content of a recommended setting. The recommended setting table 42 stores a plurality of kinds of recommended settings which is set for respective users (respective roles). The role table 43 stores information indicating the role allocated to the respective users. The recommended setting table 44 for respective roles stores information indicating a recommended setting set for the respective roles. In addition, the information stored in the role table 43 is not limited to the role allocated to the respective users but may be information indicating the classification of users.

Next, a configuration of a control system of the user terminal 2 will be described.

As shown in FIG. 2, the user terminal 2 includes a CPU (processor) 51, a random access memory (RAM) 52, a read only memory (ROM) 53, a hard disk drive (HDD) 54, a network interface 56, and the like.

The CPU 51 is a processor. The CPU 51 realizes various processing functions by executing control programs stored in the ROM 53 and the HDD 54. For example, the CPU 51 sends a print instruction to the digital multi-function peripheral 1 by executing a printer driver program for the digital multi-function peripheral 1. The CPU 51 can cause the digital multi-function peripheral 1 to execute printing with various settings using the printer driver. For example, the CPU 51 can designate various settings to the digital multi-function peripheral 1 such as color mode, duplex mode, N-in-1 mode, toner save mode, or screen mode using the printer driver.

The RAM 52 is a main memory that functions as a working memory. The ROM 53 stores a control program for controlling the operation of the digital multi-function peripheral 1, control data, and the like. The HDD 54 is a rewritable nonvolatile memory. The HDD 54 stores a control program for realizing various processing functions, control data, and the like. Moreover, the HDD 54 stores image data read by the scanner 11 or print data including image data received through a network. The network interface (NW I/F) 56 is an interface that allows the user terminal 2 to communicate data with the digital multi-function peripheral 1 through the network 3.

The HDD 54 includes a Quota table 61. The Quota table 61 may store the same information as the Quota table 41 stored in the HDD 34 of the digital multi-function peripheral 1. For example, the CPU 51 calculates the amount of consumption of the Quota value for a setting content made up of a plurality of setting items based on the amount of consumption of the Quota value for the respective setting items stored in the Quota table 61. In addition, it is necessary to maintain consistency between the information stored in the Quota table 61 and the information stored in the Quota table 41 of the digital multi-function peripheral 1. Therefore, the Quota table 61 is updated appropriately in synchronization with updating of the Quota table 41 of the digital multi-function peripheral 1.

Next, an exemplary configuration of the respective tables 41, 42, 43, 44, and 61 will be described.

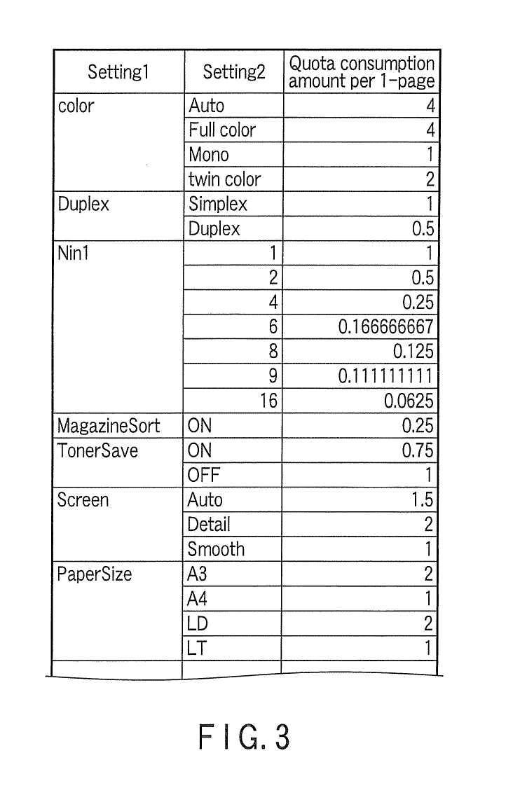

FIG. 3 shows an exemplary configuration of the Quota tables 41 and 61.

As shown in FIG. 3, the Quota tables 41 and 61 store the amount of consumption of the Quota value for each setting item. The digital multi-function peripheral 1 includes the Quota table 41, and the user terminal 2 includes the Quota table 61 having the same content as the Quota table 41. The user terminal 2 and the digital multi-function peripheral 1 calculate the amount of consumption of the Quota value for the entirety of the individual print setting contents made up of a plurality of setting items based on the information stored in the Quota tables 41 and 61.

The user terminal 2 updates the Quota table 61 appropriately in synchronization with updating of the Quota table 41 of the digital multi-function peripheral 1. Moreover, a master Quota table may be provided in a server device connected to the network 3, and the digital multi-function peripheral 1 and the user terminal 2 may update the Quota tables 41 and 61 appropriately. Furthermore, the user terminal 2 may acquire the information stored in the Quota table 41 of the digital multi-function peripheral 1 as necessary from the digital multi-function peripheral 1 through the network 3 to thereby omit the Quota table 61.

In the example shown in FIG. 3, the Quota tables 41 and 61 show the amount of consumption of the Quota value for “Auto,” “Full color,” “Mono (monochrome),” and “Twin color” as settings of Color mode. For example, the amount of consumption of the Quota value per one page is “4” for “Auto,” “4” for “Full color,” “1” for “Mono,” and “2” for “Twin color,” respectively. This indicates that the “Full color” setting consumes the largest Quota value, and the “Mono” setting consumes the smallest Quota value.

In the example shown in FIG. 3, the Quota tables 41 and 61 show the amount of consumption of the Quota value for “Simplex” and “Duplex” as settings of Duplex mode. For example, the amount of consumption of the Quota value per one page is “1” for “Simplex” and “0.5” for “Duplex,” respectively. This indicates that the amount of consumption of the Quota value for the “Duplex” setting is half the amount of consumption of the Quota value for the “Simplex” setting.

In the example shown in FIG. 3, the Quota tables 41 and 61 show the amount of consumption of the Quota value for “1-in-1 (same magnification),” “2-in-1,” “4-in-1,” “6-in-1,” “8-in-1,” “9-in-1,” and “16-in-1” as settings of N-in-1 mode. For example, the amount of consumption of the Quota value per one page is “1” for “1-in-1,” “0.5” for “2-in-1,” “0.25” for “4-in-1,” “0.167” for “6-in-1,” “0.125” for “8-in-1,” “0.111” for “9-in-1,” and “0.0625” for “16-in-1,” respectively.

In the example shown in FIG. 3, the Quota tables 41 and 61 show the amount of consumption of the Quota value per one page for Magazine Sort mode, which is “0.25” if the mode is “ON.” The Magazine Sort mode which is “ON” means that the “2-in-1” and “Duplex” settings are selected. Thus, the amount of consumption of the Quota value for Magazine Sort mode may be calculated as “0.5”×“0.5”=“0.25.”

In the example shown in FIG. 3, the Quota tables 41 and 61 show the amount of consumption of the Quota value for “ON” and “OFF” as settings of Toner Save mode. For example, the amount of consumption of the Quota value per one page is “0.75” and “1” if the Toner Save Mode is “ON” and “OFF,” respectively.

In the example shown in FIG. 3, the Quota tables 41 and 61 show the amount of consumption of the Quota value for “Auto,” “Detail,” and “Smooth” as settings of Screen mode. For example, the amount of consumption of the Quota value per one page is “1.5” for “Auto,” “2” for “Detail,” and “1” for Smooth,” respectively.

In the example shown in FIG. 3, the Quota tables 41 and 61 show the amount of consumption of the Quota value for “A3,” “A4,” “LD,” and “LT” as settings of Paper Size. For example, the amount of consumption of the Quota value per one page is “2” for “A3,” “1” for “A4,” “2” for “LD,” and “1” for “LT,” respectively.

The CPU 31 of the digital multi-function peripheral 1 and the CPU 51 of the user terminal 2 calculates the amount of consumption of the Quota value for the entirety of the setting contents made up of a plurality of setting items based on the amount of consumption of the Quota value for the respective kinds of setting items stored in the Quota tables 41 and 61 as described above. For example, the CPU 31 of the digital multi-function peripheral 1 and the CPU 51 of the user terminal 2 multiply the amounts of consumption of the Quota value for the respective setting items included in one setting content to thereby calculate the amount of consumption of the Quota value for the entirety of the setting contents.

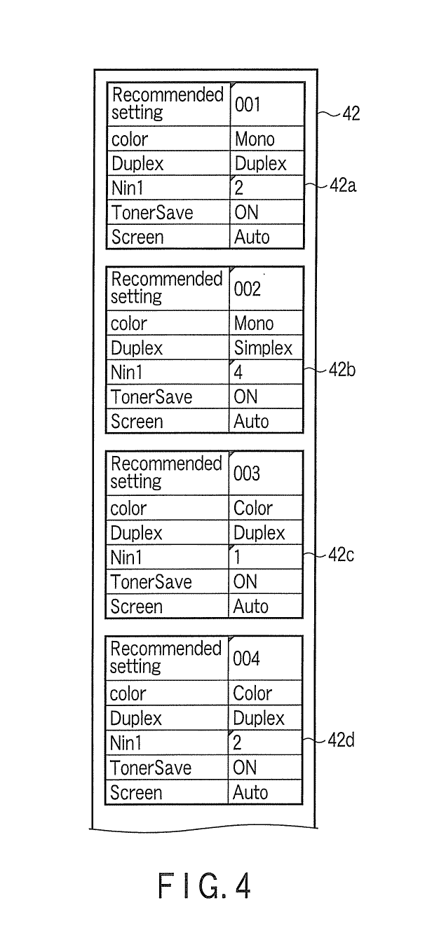

FIG. 4 shows an exemplary configuration of the recommended setting table 42.

As shown in FIG. 4, the recommended setting table 42 stores a recommended setting presented to respective users. In the exemplary configuration shown in FIG. 4, the recommended setting table 42 includes recommended setting tables 42a to 42d for each of a plurality of recommended setting contents. The respective recommended setting tables 42a to 42d store the content of the respective recommended settings so as to correspond to a unique setting ID allocated thereto.

In the recommended setting table 42 shown in FIG. 4, the recommended setting table 42a whose setting ID is “001” stores the setting contents including “Mono,” “Duplex,” “2-in-1,” “Toner Save ON,” and “Screen Auto” as recommended setting. The recommended setting table 42b whose setting ID is “002” stores the setting contents including “Mono,” “Simplex,” “4-in-1,” “Toner Save ON,” and “Screen Auto” as recommended settings. The recommended setting table 42c whose setting ID is “003” stores the setting contents including “Color,” “Duplex,” “1-in-1,” “Toner Save ON,” and “Screen Auto” as recommended settings. The recommended setting table 42d whose setting ID is “004” stores the setting contents including “Color,” “Duplex,” “2-in-1,” “Toner Save ON,” and “Screen Auto” as recommended settings.

According to the recommended setting table 42 having the configuration shown in FIG. 4, various recommended settings can be designated by the setting ID.

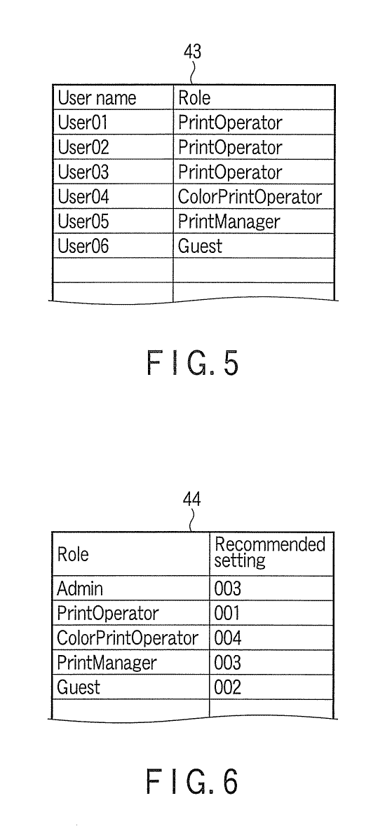

FIG. 5 shows an exemplary configuration of the role table 43.

As shown in FIG. 5, the role table 43 stores information indicating the role allocated to the respective users. In the exemplary configuration shown in FIG. 5, the role table 43 allocates the roles “Print Operator” to Users 01, 02, and 03, “Color Print Operator” to User 04, “Print Manager” to User 05, and “Guest” to User 06, respectively.

According to the role table 43 having the configuration shown in FIG. 5, the roles allocated to the respective users can be easily identified.

FIG. 6 shows an exemplary configuration of the recommended setting table 44 for respective roles.

As shown in FIG. 6, the recommended setting table 44 for respective roles stores information indicating the recommended setting allocated to respective roles. In the exemplary configuration shown in FIG. 6, the recommended setting table 44 for respective roles allocates the recommended settings whose setting IDs are “003,” “001,” “004,” “003,” and “002” to “Admin,” “Print Operator,” “Color Print Operator,” “Print Manager,” and “Guest,” respectively.

According to the respective tables 41 to 44 described above, the recommended setting can be registered for each of the roles allocated to the respective users. For example, the roles allocated to the respective users and the setting ID of the recommended settings for the roles can be determined by referencing the role table 43 shown in FIG. 5 and the recommended setting table 44 for respective roles shown in FIG. 6. In addition, the recommended setting for a user (a role allocated to the user) can be easily specified by reading the recommended setting corresponding to the setting ID from the recommended setting table 42 shown in FIG. 4.

Moreover, the amount of consumption of the Quota value for the respective recommended settings designated by the setting ID can be calculated with reference to the Quota tables 41 and 61 shown in FIG. 3. The amount of consumption of the Quota value for the respective recommended settings may be calculated in each case and may be calculated in advance and stored in the recommended setting table 42 together with the recommended setting information.

Next, a print process including a print setting process, performed by the user terminal 2 will be described.

In the present embodiment, the user terminal 2 issues a print request to the digital multi-function peripheral 1 using a printer driver. The digital multi-function peripheral 1 provides a recommended setting to the user terminal 2. The user terminal 2 receives print setting information input by a user while providing print setting candidates based on the recommended setting acquired from the digital multi-function peripheral 1 and the amount of consumption of the Quota value for respective setting contents.

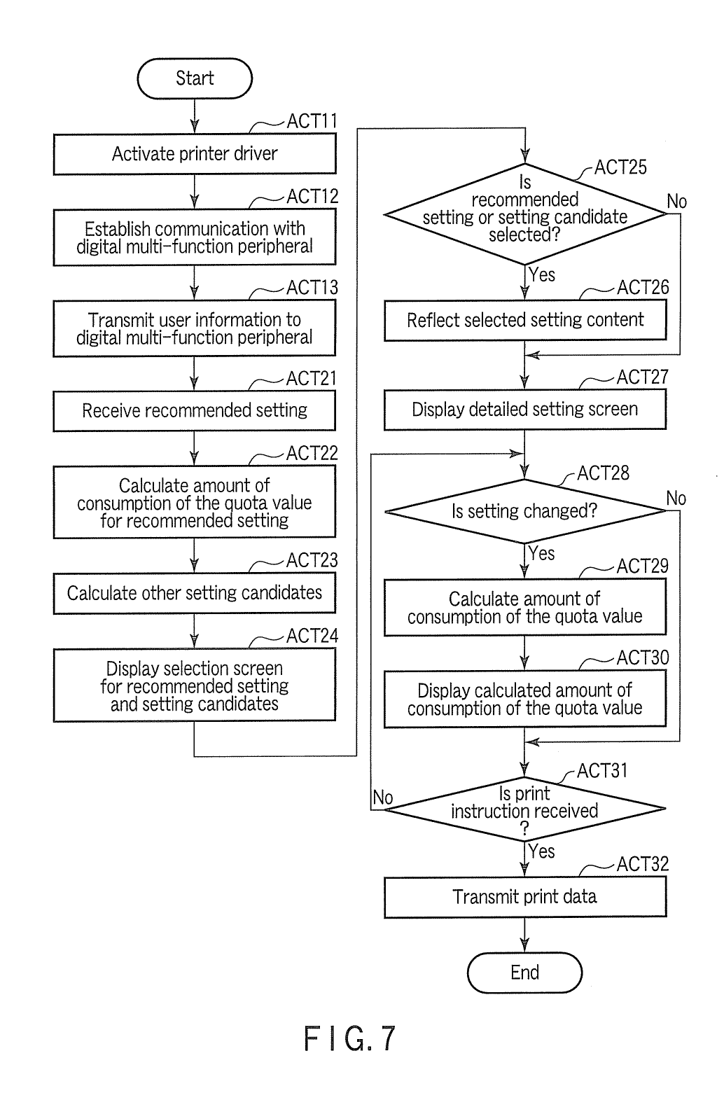

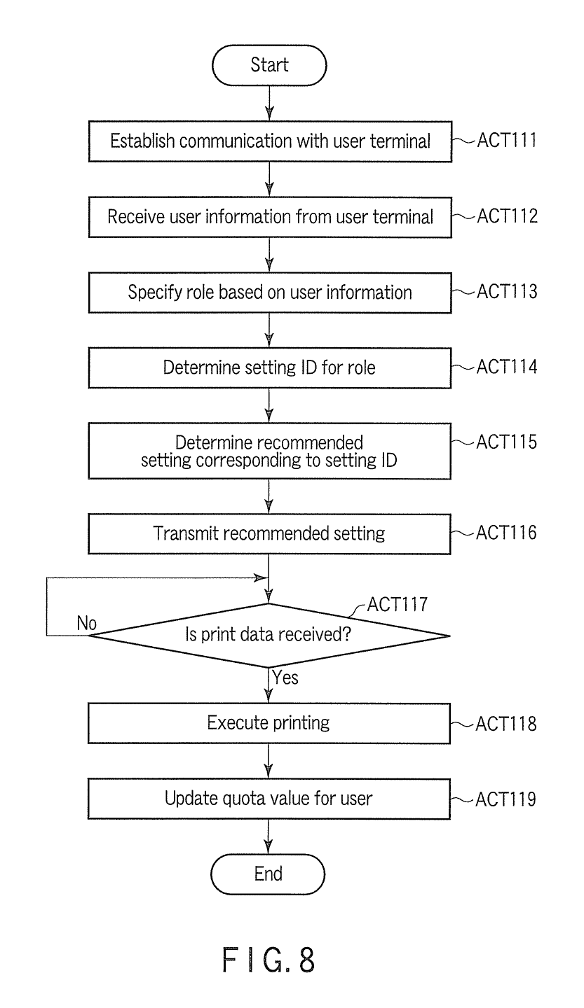

FIG. 7 is a flowchart showing an exemplary operation of the user terminal 2 during a print process. FIG. 8 is a flowchart showing an exemplary operation of the digital multi-function peripheral 1 during a print process.

For example, if a user issues an instruction to print image data or document data to the user terminal 2, the CPU 51 of the user terminal 2 activates a printer driver as a program for issuing a print request to the digital multi-function peripheral 1. That is, in response to an instruction from a user who wants to perform printing using the digital multi-function peripheral 1, the CPU 51 of the user terminal 2 activates a printer driver stored in the HDD 54 (ACT 11).

In this embodiment, it is assumed that the user terminal has already acquired information (user information) capable of identifying a user who activates the printer driver (namely, a user who issues a print instruction using the printer driver). The information capable of identifying the user may be a user ID (or a login ID) that the user inputs if starting the user terminal 2, may be information indicating a user corresponding to the user terminal 2 or print data, and may be information indicating a user who has been successfully authenticated through user authentication.

If the printer driver is activated, the CPU 51 of the user terminal 2 establishes communication with the digital multi-function peripheral 1 through the network 3 using the network interface 56 (ACT 12). If communication with the digital multi-function peripheral 1 is enabled, the CPU 51 transmits user information indicating a user who issues a print instruction using the active printer driver to the digital multi-function peripheral 1 (ACT 13). After transmitting the user information, the user terminal 2 enters a standby state until it receives a recommended setting from the digital multi-function peripheral 1.

On the other hand, the CPU 31 of the digital multi-function peripheral 1 performs processing for establishing communication with the user terminal 2 in response to a connection request from the user terminal 2 (ACT 111). If communication with the user terminal 2 is enabled, the digital multi-function peripheral 1 receives the user information from the user terminal 2 that activated the printer driver using the network interface 36 (ACT 112). The CPU 31 of the digital multi-function peripheral 1 specifies the role allocated to the user with reference to the role table 43 based on the user information received from the user terminal 2 (ACT 113). If the role of the user is specified, the CPU 31 determines the setting ID of the recommended setting for the specified role with reference to the recommended setting table 44 for respective roles (ACT 114). The CPU 31 specifies the recommended setting corresponding to the determined setting ID (ACT 115).

If the recommended setting for the user is specified, the CPU 31 transmits information indicating the content of the recommended setting for the user (the user corresponding to the received user information) to the user terminal 2 (ACT 116). In this case, the CPU 31 of the digital multi-function peripheral 1 may calculate the amount of consumption of the Quota value for the specified recommended setting based on the Quota table 41 and transmit the calculated amount of consumption of the Quota value to the user terminal 2 together with the information indicating the content of the recommended setting. Moreover, the amount of consumption of the Quota value corresponding to the recommended setting, calculated based on the Quota table 41 may be stored in advance in the recommended setting table 42 of the digital multi-function peripheral 1. In addition, in this process example, it is assumed that the information indicating the content of the recommended setting for the user is transmitted to the user terminal 2.

In the user terminal 2, the network interface 56 receives the information indicating the recommended setting from the digital multi-function peripheral 1 (ACT 21). Upon acquiring the recommended setting from the digital multi-function peripheral 1, the CPU 51 of the user terminal 2 calculates the amount of consumption of the Quota value for the acquired recommended setting based on the Quota table 61 (ACT 22). For example, the CPU 51 specifies the amount of consumption (the weighting value) of the Quota value for each of the setting items included in the recommended setting with reference to the Quota table 61. The CPU 51 multiplies the amounts of consumption of the Quota value for the respective setting items included in the recommended setting to thereby calculate the amount of consumption of the Quota value for the entirety of the recommended setting. Moreover, as the amount of consumption of the Quota value for the recommended setting, the CPU 51 may calculate the amount of consumption of the Quota value per one page and may calculate the amount of consumption of the Quota value for the total number of printing pages. In addition, if the amount of consumption of the Quota value for the recommended setting is received together with the information indicating the recommended setting, the CPU 51 of the user terminal 2 may omit the process of ACT 21.

If the amount of consumption of the Quota value for the recommended setting is calculated, the CPU 51 selects setting candidates of which the amount of consumption of the Quota value is equal to or smaller than the amount of consumption of the Quota value for the recommended setting (ACT 23). That is, the CPU 51 selects setting candidates with reference to the amount of consumption of the Quota value for the recommended setting. For example, if the amount of consumption of the Quota value for the recommended setting is “0.25,” the CPU 51 selects setting candidates of which the amount of consumption of the Quota value is equal to or smaller than “0.25.” Moreover, the CPU 51 selects a number of setting candidates which can be displayed together with the recommended setting on a setting selection screen displayed on the display section 22.

If the setting candidates are selected, the CPU 51 displays the recommended setting and the respective selected setting candidates on the display section 22 (ACT 24). The CPU 51 receives a user's choice on the recommended setting or the respective setting candidates displayed on the display section 22 (ACT 25). If the user has selected any one of the recommended setting and the setting candidates (ACT 25: YES), the CPU 51 reflects the setting content of the selected recommended setting or the selected print setting candidate on the present setting content (ACT 26). If the user's choice is reflected on the present setting content, the CPU 51 displays a detailed setting screen showing the present setting content on the display section 22 (ACT 27). Moreover, none of the recommended setting and the print setting candidates has been selected (ACT 25: NO), the CPU 51 displays a detailed setting screen reflecting a standard setting (default setting) on the display section 22 (ACT 27).

In a state where the detailed setting screen is displayed on the display section 22, the CPU 51 receives user instructions to change the setting content for each setting item or to start printing. If the setting content is changed (ACT 28: YES), the CPU 51 calculates the amount of consumption of the Quota value for the changed setting content (ACT 29). The CPU 51 displays the calculated amount of consumption of the Quota value on the display section 22 (ACT 30). Moreover, if a print start instruction is received from the user (ACT 31: YES), the CPU 51 generates print data (PDL data) for requesting printing with the present setting content and transmits the generated print data to the digital multi-function peripheral 1 (ACT 32).

After transmitting the recommended setting to the user terminal 2, the digital multi-function peripheral 1 enters a state where it can receive print data from the user terminal 2. If print data is received from the user terminal 2 in this state (ACT 117: YES), the CPU 31 of the digital multi-function peripheral 1 executes a print process using the printer 12 in accordance with the print setting included in the received print data (ACT 118). If the print process ends, the CPU 31 update the Quota value allocated to the user who has issued the print request (ACT 119). That is, the CPU 31 subtracts the amount of consumption of the Quota value for the executed printing from the Quota value allocated to the user who has issued the print request to thereby update the Quota value allocated to the user who has issued the print request.

Through the above processes, the print process in the digital multi-function peripheral 1 in response to the print request based on the print setting set by the user terminal 2 ends.

In addition, the CPU 51 of the user terminal 2 may determine whether the information stored in the Quota table 61 is equivalent to the information stored in the Quota table 41 of the digital multi-function peripheral 1 after communication with the digital multi-function peripheral 1 is established. This determination may be made by the CPU 31 of the digital multi-function peripheral 1. If the information stored in the Quota table 61 is determined to be different from the information stored in the Quota table 41, the CPU 51 of the user terminal 2 updates the information stored in the Quota table 61 in accordance with the information stored in the Quota table 41 of the digital multi-function peripheral 1.

Moreover, the user terminal 2 may not have a Quota table but may appropriately acquire information to be stored in a Quota table from the digital multi-function peripheral 1. Furthermore, the user terminal 2 may request the digital multi-function peripheral 1 to calculate the amount of consumption of the Quota value for the setting content and acquire the amount of consumption of the Quota value for the setting content, calculated by the digital multi-function peripheral 1.

Next, an example of displaying the recommended setting and the print setting candidates on the display section 22 of the user terminal 2 will be described.

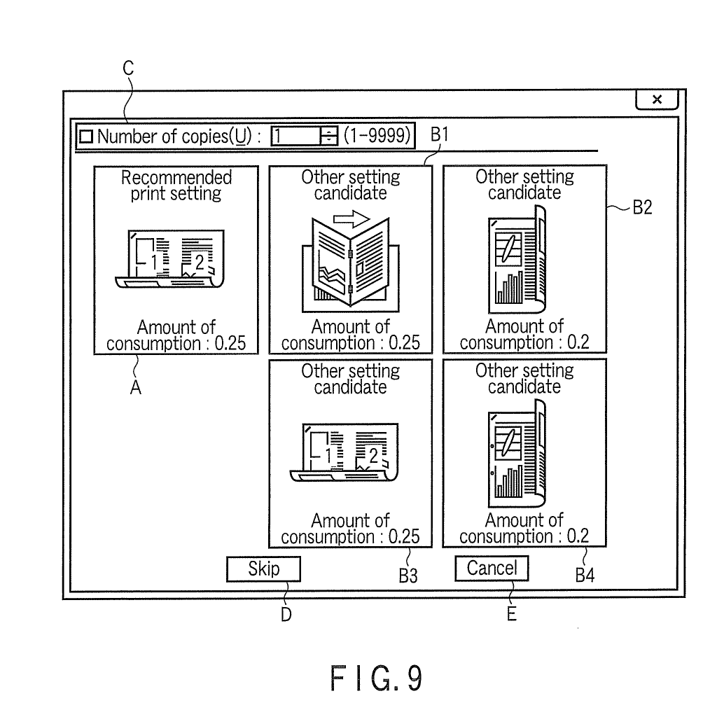

FIG. 9 shows a display example of a print setting screen displayed on the display section 22 of the user terminal 2.

In the display example shown in FIG. 9, the display section 22 displays a recommended setting icon A and four setting candidate icons B1 to B4. The CPU 51 displays character information indicating the setting content, a print result image, and the amount of consumption of the Quota value per one page (or the amount of consumption of the Quota value for the total number of pages) with respect to the recommended setting icon A and the respective setting candidate icons B1 to B4.

For example, for the recommended setting icon A, the character information “recommended print setting,” a print result image obtained through printing with the recommended setting, and the amount of consumption of the Quota value per one page for the recommended setting are displayed. Moreover, for the respective setting candidate icons B1 to B4, the character information “other setting candidates,” a print result image obtained through printing with the respective settings, and the amount of consumption of the Quota value per one page are displayed.

For example, in the display example shown in FIG. 9, if any one of the icons is selected, the CPU 51 displays a detailed setting screen reflecting the setting content of the selected icon on the display section 22. In the state where the detailed setting screen is displayed on the display section 22, the CPU 51 receives user instructions to change the setting content for each setting item or to start printing. If the setting content is changed, the CPU 51 calculates the amount of consumption of the Quota value for the changed setting content and displays the calculated amount of consumption of the Quota value on the display section 22.

Moreover, in the display example shown in FIG. 9, the display section 22 displays a number-of-copies input field C, a skip icon D, and a cancel icon E together with the respective setting icons A and B1 to B4. In the number-of-copies input field C, the number of copies is input through operation of the operation section 23. The skip icon D is pressed if the user wants to skip selecting the settings of the recommended setting icon A and the respective setting candidate icons B1 to B4 shown in FIG. 9. For example, if the skip icon D is pressed, the CPU 51 displays a detailed setting screen reflecting the standard setting. In the detailed setting screen, the user can input the setting content of the respective setting items using the operation section 23. Moreover, the cancel icon E is an icon for canceling print settings.

According to the print process described above, the user terminal 2 can easily apply the recommended setting which is set by an administer while taking the amount of consumption of the Quota value into account as the print setting for a print process executed by the digital multi-function peripheral 1 and presents the amount of consumption of the Quota value for the recommended setting to the user. Moreover, the user terminal 2 can present the setting candidates of which the amount of consumption of the Quota value is equal to or smaller than the amount of consumption of the Quota value for the recommended setting to the user. Furthermore, the user terminal 2 can present the amount of consumption of the Quota value for the present print setting content to the user if ever the print setting for the print process executed by the digital multi-function peripheral 1 is changed.

Next, a process of registering the recommended setting will be described.

In the example of the print process described above, the recommended setting stored in advance in the digital multi-function peripheral 1 is provided to the user. It is assumed that the recommended setting is designated and registered by an administrator. In the above example, the recommended setting is set for each role allocated to the respective users. Therefore, the administrator needs to input the recommended setting while taking the amount of consumption of the Quota value for each role of the user into account. If the administrator performs the process of registering the recommended setting, the digital multi-function peripheral 1 calculates the amount of consumption of the Quota value for the setting content appropriately and presents the calculated amount of consumption of the Quota value.

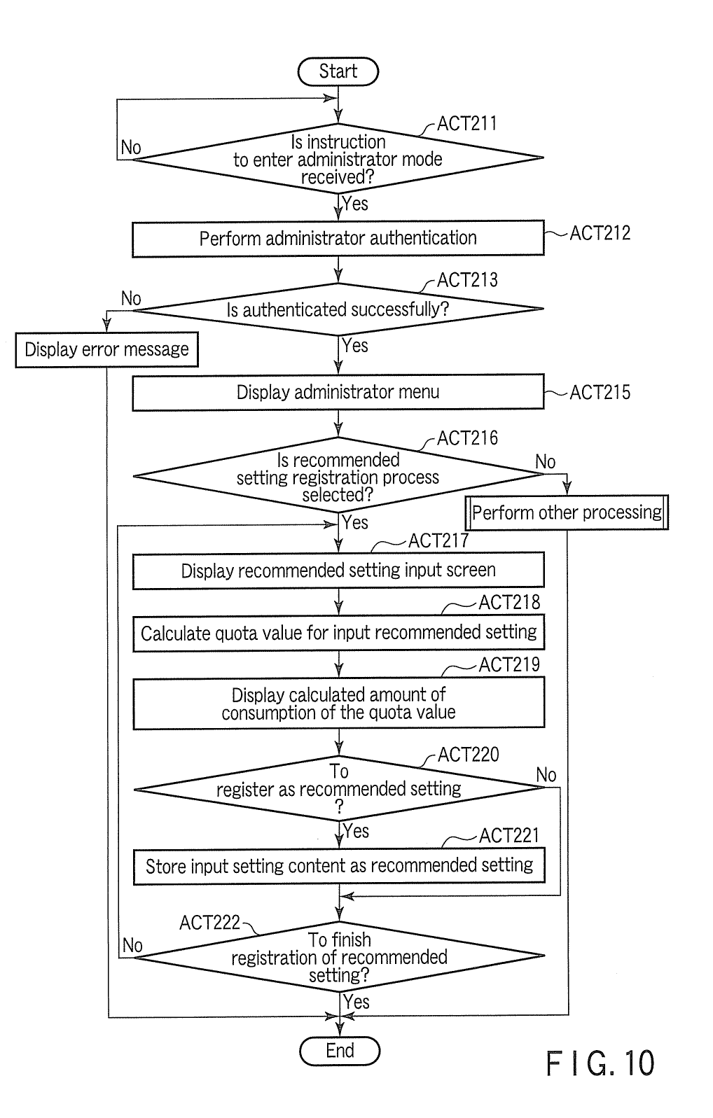

FIG. 10 is a flowchart showing an example of the process of registering the recommended setting.

First, the CPU 31 of the digital multi-function peripheral 1 authenticates whether the operator is an administrator in response to an instruction to enter an administrator mode. The administrator may perform an operation using the operation panel 13 of the digital multi-function peripheral 1 and may perform an operation using a user terminal (administrator terminal) 2 which is used by the administrator and is capable of communicating with the digital multi-function peripheral 1 through the network 3. If the administrator performs the recommended setting registration process by operating the administrator terminal 2 capable of communicating with the digital multi-function peripheral 1 through the network 3, the digital multi-function peripheral 1 may provide an input screen or the like for the recommended setting registration process on the Web, for example.

That is, if an instruction to enter an administrator mode is received from the operation panel 13 or the administrator terminal 2 (ACT 211: YES), the CPU 31 of the digital multi-function peripheral 1 performs an authentication process of authenticating whether the operator is an administrator (ACT 212). If the operator is not authenticated as the administrator (ACT 213: NO), the CPU 31 of the digital multi-function peripheral 1 displays an authentication error message on the display section 14 of the operation panel 13 or the display section 22 of the administrator terminal 2 (ACT 214) and finishes the process.

If the operator is authenticated as the actual measurement data (ACT 213: YES), the CPU 31 of the digital multi-function peripheral 1 displays a menu screen for the administrator on the display section 14 of the operation panel 13 or the display section 22 of the administrator terminal 2 (ACT 215). For example, the CPU 51 displays a selection screen for selecting various setting processes including the recommended setting registration process as the menu screen for the administrator.

If the recommended setting registration process is selected (ACT 216: YES), the CPU 51 displays a recommended setting input screen on the display section 14 or the display section 22 (ACT 217). For example, the recommended setting input screen may be one for inputting the setting content of the recommended setting to be stored in the recommended setting table 42 described above, may be one for inputting the information to be stored in the role table 43, and may be one for inputting the information to be stored in the recommended setting table 44 for the respective roles. In this example, it is assumed that an input screen including the detailed setting screen for inputting the setting content of the respective setting items is displayed as the recommended setting input screen.

For example, if the recommended setting input screen is displayed on the display section 14 of the digital multi-function peripheral 1, the administrator inputs the setting content of the recommended setting using the operation panel 13. Moreover, if the recommended setting input screen is displayed on the display section 22 of the administrator terminal 2, the administrator inputs the setting content of the recommended setting using the operation section 23.

If the setting content of the recommended setting is input, the CPU 31 of the digital multi-function peripheral 1 calculates the amount of consumption of the Quota value for the input setting content with reference to the Quota table 41 (ACT 218). If the amount of consumption of the Quota value is calculated, the CPU 31 displays the calculated amount of consumption of the Quota value on the display section 14 or the display section 22 (ACT 219). In addition, if the setting content of the recommended setting is input using the operation section 23 of the administrator terminal 2, the CPU 51 of the user terminal 2 may calculate the amount of consumption of the Quota value for the input setting content with reference to the Quota table 61. In this case, the CPU 51 displays the calculated amount of consumption of the Quota value on the display section 22.

In the state where the amount of consumption of the Quota value for the input setting content is displayed, the administrator inputs an instruction as to whether the input setting content (the setting content for which the amount of consumption of the Quota value is displayed) will be registered as the recommended setting. If the administrator instructs to register the input setting content as the recommended setting (ACT 220: YES), the CPU 31 issues a setting ID that is unique to the input setting content and stores the recommended setting and the issued setting ID in the recommended setting table 42 in a correlated manner (ACT 221).

Moreover, if the user (or the role thereof) to which the recommended setting is applied is designated (or changed) (ACT 220: YES), the CPU 31 updates the recommended setting table 44 for the respective roles (ACT 221). For example, the CPU 31 updates the setting ID corresponding to the designated user (role) in the recommended setting table 44 for the respective roles with the setting ID of the recommended setting to be applied.

Through the above processes, registration of the recommended setting is completed. Subsequently, if registering another recommended setting (ACT 222: NO), the CPU 31 displays the recommended setting input screen again and repeatedly executes the processes starting with ACT 217.

According to the above processes, the administrator who has successfully authenticated as the administrator through the authentication process can perform the recommended setting registration process in the digital multi-function peripheral 1 or the administrator terminal 2 while checking the amount of consumption of the Quota value for the input setting content.

Next, a print setting process by the digital multi-function peripheral 1 will be described.

The process of displaying the recommended setting set for each user (role) and the print setting candidates selected based on the recommended setting together with the amount of consumption of the Quota value as in the display example shown in FIG. 9 can be applied to the setting of a job (for example, a copy process) using the operation panel 13 and the display section 14 of the digital multi-function peripheral 1.

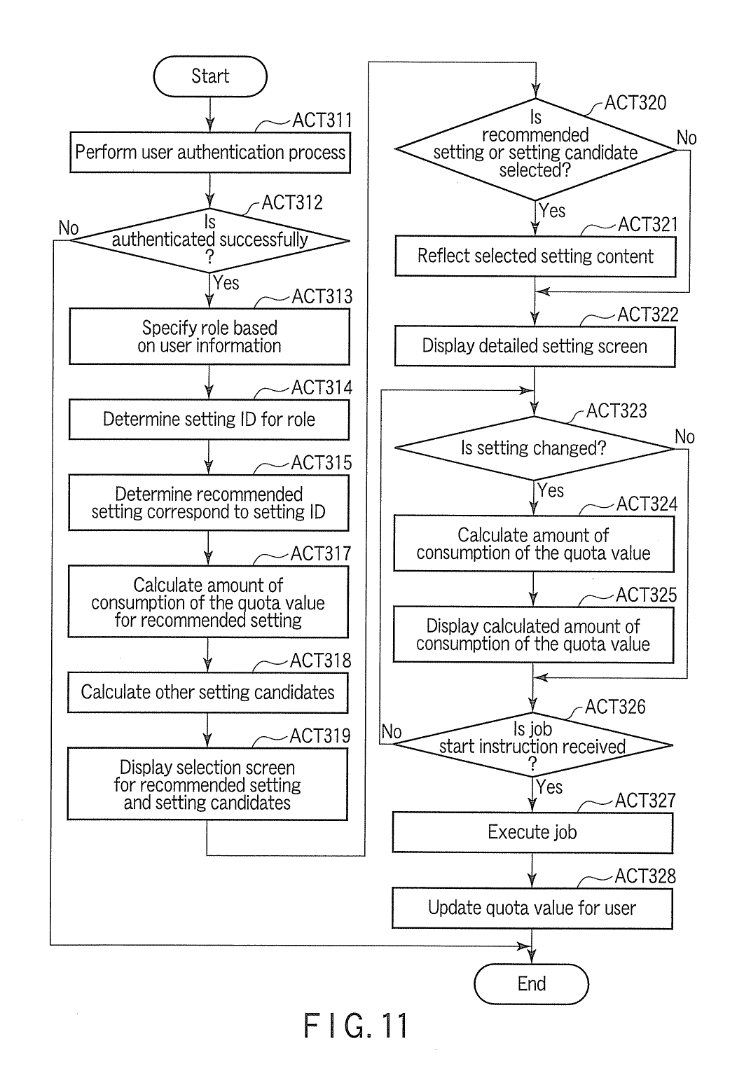

FIG. 11 is a flowchart showing an exemplary process including a job (copy) setting process, performed by the digital multi-function peripheral 1.

In this example, a process in which the digital multi-function peripheral 1 executes a copy process in accordance with an operation of a user who has been successfully authenticated through user authentication will be described as an example. It is assumed that the digital multi-function peripheral 1 is configured such that it can be used by only a user who has been successfully authenticated through user authentication. In such a configuration, a user who wants to make copies using the digital multi-function peripheral 1 inputs information for user authentication to the digital multi-function peripheral 1. The CPU 31 of the digital multi-function peripheral 1 performs a user authentication process based on the information that the user inputs for user authentication (ACT 311).

The digital multi-function peripheral 1 may acquire information capable of identifying a user in order to specify the recommended setting for a copy process corresponding to the user. For example, the user information may be a user ID that the user inputs using a numeric keypad or the like.

If the user has been successfully authenticated through the user authentication process (ACT 312: YES), the CPU 31 of the digital multi-function peripheral 1 specifies the role with reference to the role table 43 based on the user information obtained as the result of the user authentication (ACT 313). If the role is specified, the CPU 31 determines the setting ID of the recommended setting for the specified role with reference to the recommended setting table 44 for the respective roles (ACT 314). The CPU 31 specifies the recommended setting corresponding to the determined setting ID from the recommended setting table 42 (ACT 315).

In this example, it is assumed that the process executed by the digital multi-function peripheral 1 is a copy process. Therefore, the recommended setting selected by the CPU 31 is the recommended setting for the copy process for the user. That is, in the HDD 34 of the digital multi-function peripheral 1, the recommended setting for each of various jobs may be registered for the respective users in the recommended setting table 42 or the like. For example, the HDD 34 of the digital multi-function peripheral 1 may store the recommended setting for network printing and the recommended setting for the copy process for each of the individual users (or roles).

If the recommended setting for the job (copy process) is specified, the CPU 31 calculates the amount of consumption of the Quota value for the specified recommended setting based on the Quota table 41 (ACT 317). For example, the CPU 31 specifies the amount of consumption (the weighing value) of the Quota value for each of the setting items included in the recommended setting with reference to the Quota table 41. The CPU 31 calculates the amount of consumption of the Quota value for the recommended setting by multiplying the amounts of consumption (the weighting values) of the Quota value for the respective setting items included in the recommended setting. The CPU 31 may calculate the amount of consumption of the Quota value per one page as the amount of consumption of the Quota value by the job (copy process) with the recommended setting and may calculate the amount of consumption of the Quota value for the entire jobs (copy processes).

In addition, the recommended setting table 42 may store the amount of consumption of the Quota value by the job with the respective recommended setting so as to be correlated with the respective recommended setting. In this case, the CPU 31 may omit the process of ACT 317 and read the amount of consumption of the Quota value from the recommended setting table 42 together with the recommended setting.

If the amount of consumption of the Quota value for the recommended setting is calculated, the CPU 31 selects other setting candidates of which the amount of consumption of the Quota value is equal to or smaller than the amount of consumption of the Quota value for the recommended setting (ACT 318). For example, the CPU 31 selects a number of setting candidates which can be displayed together with the recommended setting on a setting selection screen displayed on the display section 14. If displaying the recommended setting and the setting candidates, the same selection screen as that shown in FIG. 9 may be displayed on the display section 14.

If the setting candidates are selected, the CPU 31 displays the recommended setting and the respective selected setting candidates on the display section 14 (ACT 319). The CPU 31 receives a user's choice on the recommended setting or the respective setting candidates displayed on the display section 14 (ACT 320). If the user has selected any one of the recommended setting and the setting candidates (ACT 320: YES), the CPU 31 reflects the setting content of the selected recommended setting or the selected print setting candidate on the present setting content (ACT 321). If the user's choice is reflected on the present setting content, the CPU 31 displays a detailed setting screen showing the present setting content on the display section 14 (ACT 322). Moreover, none of the recommended setting and the setting candidates has been selected (ACT 320: NO), the CPU 31 displays a detailed setting screen reflecting a standard setting (default setting) on the display section 14 (ACT 322).

In a state where the detailed setting screen is displayed on the display section 14, the CPU 31 receives user instructions to change the setting content for each setting item or to start printing. If the setting content is changed (ACT 323: YES), the CPU 31 calculates the amount of consumption of the Quota value for the changed setting content (ACT 324). The CPU 31 displays the calculated amount of consumption of the Quota value on the display section 14 (ACT 325).

Moreover, if an instruction to start a job (copy process) is received from the user (ACT 326: YES), the CPU 31 operates the respective parts in accordance with the present setting content to start the job (ACT 327). For example, if an instruction to start the copy process is received, the CPU 31 executes the copy process using the scanner 11 and the printer 12 in accordance with the present setting content. If the job (copy process) ends, the CPU 31 update the Quota value allocated to the user who has issued the job request (ACT 328). That is, the CPU 31 subtracts the amount of consumption of the Quota value for the executed job (copy process) from the Quota value allocated to the user who has issued the job (copy process) request to thereby update the Quota value allocated to the user who has issued the job request.

According to the processes described above, the digital multi-function peripheral 1 can present the recommended setting which is set for each user by an administer while taking the amount of consumption of the Quota value into account and the amount of consumption of the Quota value for the recommended setting to the respective users. Moreover, the digital multi-function peripheral 1 can present the setting candidates of which the amount of consumption of the Quota value is equal to or smaller than the amount of consumption of the Quota value for the recommended setting to the user. Furthermore, the digital multi-function peripheral 1 can calculate the amount of consumption of the Quota value for the present print setting content and present the calculated amount of consumption of the Quota value to the user if ever the job setting is changed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A print instruction device that issues a print request to an image forming apparatus, comprising:
an acquisition section that acquires recommended setting corresponding to user information from the image forming apparatus;
a calculation section that calculates the amount of consumption of a Quota value by a print process according to the recommended setting that the acquisition section acquired from the image forming apparatus;
a display section that displays the recommended setting acquired by the acquisition section and the amount of the Quota value consumed by the print process according to the recommended setting, calculated by the calculation section; and
a transmission section that transmits print data including a print setting content instructed by a user to the image forming apparatus after the recommended setting is displayed on the display section.

2. The device according to claim 1, further comprising:
a setting section that reflects the recommended setting on the print setting content in accordance with a choice on the recommended setting displayed on the display section,
wherein the transmission section transmits print data including the print setting content set by the setting section to a digital multi-function peripheral.

3. The device according to claim 2,
wherein the setting section changes the print setting content in accordance with a user instruction to change a setting content after reflecting the recommended setting on the print setting content.

4. The device according to claim 1,
further comprising a selection section that selects other setting candidates based on the amount of consumption of the Quota value for the recommended setting,
wherein the display section displays the recommended setting and the respective setting candidates selected by the selection section on a selection screen.

5. The device according to claim 4,
wherein the selection section selects other setting candidates of which the amount of consumption of the Quota value is equal to or smaller than the amount of consumption of the Quota value for the recommended setting.

6. The device according to claim 4,
wherein the display section displays a recommended setting icon which indicates the recommended setting and the amount of consumption of the Quota value for the recommended setting and setting candidate icons which indicate the respective setting candidates and the amounts of consumption of the Quota value for the respective setting candidates.

7. The device according to claim 1,
further comprising a storage section that stores a table indicating the amounts of consumption of the Quota value for individual setting items,
wherein the calculation section calculates the amount of consumption of the Quota value for a setting content made up of a plurality of setting items based on the amount of consumption of the Quota value for the respective setting items stored in the storage section.

8. The device according to claim 1,
wherein if the print setting content is changed, the calculation section calculates the amount of consumption of the Quota value by a process according to the changed print setting content, and
wherein the display section displays the amount of consumption of the Quota value for the changed print setting content, calculated by the calculation section.

9. An image forming apparatus comprising:
a first storage section that stores a Quota value allocated to each user;
a second storage section that stores a recommended setting for each user;
a control section that executes a process in accordance with a setting content instructed by a user after displaying the recommended setting stored in the second storage section and the amount of consumption of the Quota value for the recommended setting on a display section; and
an updating section that updates the Quota value allocated to the user stored in the first storage section in accordance with the amount of consumption of the Quota value by the process executed by the control section.

10. The apparatus according to claim 9,
wherein the second storage section stores the amount of consumption of the Quota value for the recommended setting so as to be correlated with the recommended setting.

11. The apparatus according to claim 9,
further comprising a selection section that selects other setting candidates different from the recommended setting based on the amount of consumption of the Quota value for the recommended setting,
wherein the control section displays the recommended setting and the amount of consumption of the Quota value for the recommended setting, and the respective setting candidates and the amounts of consumption of the Quota value for the respective setting candidates on the display section.

12. The apparatus according to claim 11,
wherein the selection section selects the setting candidates of which the amount of consumption of the Quota value is equal to or smaller than the amount of consumption of the Quota value for the recommended setting.

13. The apparatus according to claim 11,
wherein the control section displays a recommended setting icon which indicates the recommended setting and the amount of consumption of the Quota value for the recommended setting and setting candidate icons which indicate the respective setting candidates and the amounts of consumption of the Quota value for the respective setting candidates on the display section.

14. The apparatus according to claim 9, further comprising:
a third storage section that stores a table indicating the amounts of consumption of the Quota value for the individual setting items; and
a calculation section that calculates the amount of consumption of the Quota value for a setting content made up of a plurality of setting items based on the amounts of consumption of the Quota value for the respective setting items stored in the third storage section,
wherein the updating section subtracts the amount of consumption of the Quota value for the setting content of the process executed by the control section, calculated by the calculation section from the Quota value allocated to the user.

15. The apparatus according to claim 9,
wherein if the setting content is changed, the calculation section calculates the amount of consumption of the Quota value for the changed setting content, and
wherein the control section displays the amount of consumption of the Quota value for the changed setting content, calculated by the calculation section on the display section.

16. A print instruction method for issuing a print request to an image forming apparatus, comprising:
acquiring recommended setting corresponding to user information from the image forming apparatus;
calculating the amount of consumption of a Quota value by a print process according to the recommended setting acquired from the image forming apparatus;
displaying the recommended setting and the calculated amount of consumption of the Quota value by the print process according to the recommended setting on a display section; and
transmitting print data including a print setting content instructed by a user to the image forming apparatus after displaying the recommended setting.

17. The method according to claim 16, further comprising:
reflecting the recommended setting on the print setting content in accordance with a choice on the recommended setting displayed on the display section; and
changing the print setting content in accordance with a user instruction to change a setting content after reflecting the recommended setting on the print setting content.

18. The method according to claim 16, further comprising:
selecting other setting candidates of which the amount of consumption of the Quota value is equal to or smaller than the amount of consumption of the Quota value for the recommended setting; and
displaying the recommended setting and the respective selected setting candidates on a selection screen.

19. The method according to claim 16,
wherein the amount of consumption of the Quota value for a setting content made up of a plurality of setting items is calculated based on a table indicating the amounts of consumption of the Quota value for individual setting items.

20. The method according to claim 19,
wherein if the print setting content is changed, the amount of consumption of the Quota value for the changed print setting content is calculated, and
wherein the calculated amount of consumption of the Quota value for the changed print setting content is displayed on the display section.
